(19) United States
(12) Patent Application Publication
(10) Pub. No.: US 2024/0330717 A1
(43) Pub. Date: Oct. 3, 2024

(54) MACHINE LEARNING-BASED ADJUSTMENT OF MEMORY CONFIGURATION PARAMETERS

(71) Applicant: Micron Technology, Inc., Boise, ID (US)

(72) Inventors: Yu-Chung Lien, San Jose, CA (US); Wei Wang, Dublin, CA (US); Zhenming Zhou, San Jose, CA (US)

(21) Appl. No.: 18/597,851

(22) Filed: Mar. 6, 2024

Related U.S. Application Data
(60) Provisional application No. 63/456,786, filed on Apr. 3, 2023.

(51) Int. Cl. G06N 5/022; G06F 12/02

(52) U.S. Cl. CPC G06N 5/022; G06F 12/0246

(57) ABSTRACT

A method for using and system for training a trainable model to predict values of memory configuration parameters based on a value of a performance metric. The value of the performance metric is based on a threshold condition of a memory access operation performed on a memory device using a set of values of the memory configuration parameters. The output of the trainable model includes a set of predicted values of the memory configuration parameters. Responsive to determining that the set of predicted values of the memory configuration parameters satisfies a confidence criterion, the memory configuration parameters are updated to reflect the set of predicted values of the memory configuration parameters.

### RELATED APPLICATION

This application claims the benefit of U.S. Provisional Application No. 63/456,786 filed Apr. 3, 2023, the entire contents of which are hereby incorporated by reference.

### TECHNICAL FIELD

Embodiments of the disclosure relate generally to memory sub-systems, and more specifically, relate to machine learning based memory configuration parameter construction in a memory device.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIG. 2 illustrates an example production environment associated with producing a memory device in accordance with some embodiments of the present disclosure.

FIG. 3 is a flow diagram of an example method for using a trainable model to predict memory configuration parameters, in accordance with some embodiments of the present disclosure.

FIG. 4 is a flow diagram of an example method for using a trainable model to predict memory configuration parameters, in accordance with some embodiments of the present disclosure.

FIG. 5 is a flow diagram of an example method for training a trainable model to predict memory configuration parameters, in accordance with some embodiments of the present disclosure.

FIG. 6 is a flow diagram of an example method for training a trainable model to predict memory configuration parameters, in accordance with some embodiments of the present disclosure.

FIG. 7 is a block diagram of an example computer system in which embodiments of the present disclosure may operate.

### DETAILED DESCRIPTION

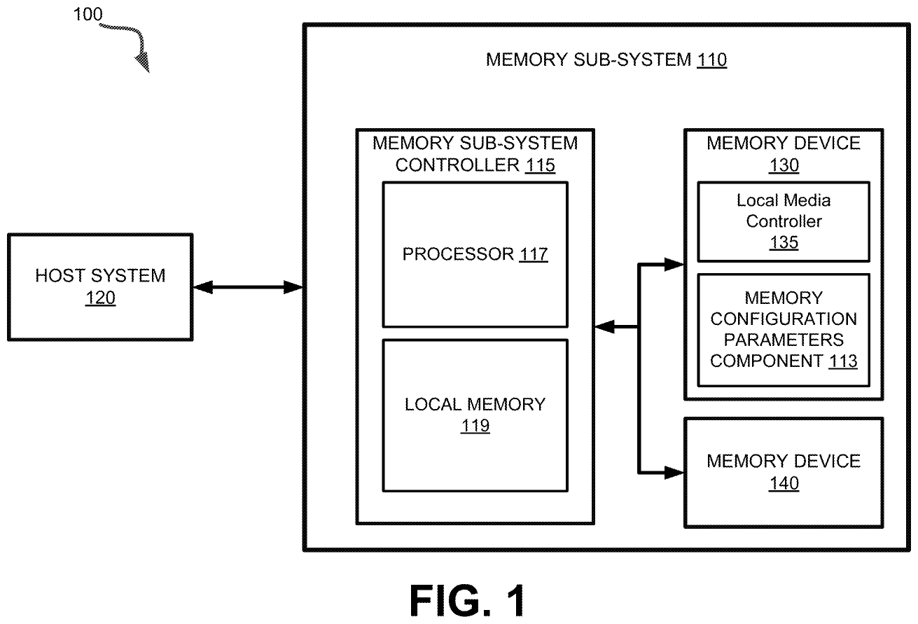

Aspects of the present disclosure are directed to machine learning based memory configuration parameter construction. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a negative-and (NAND) memory device. Other examples of non-volatile memory devices are described below in conjunction with FIG. 1. A non-volatile memory device is a package of one or more dies. Each die can include of one or more planes. For some types of non-volatile memory devices (e.g., NAND devices), each plane includes of a set of physical blocks. In some implementations, each block can include multiple sub-blocks. Each sub-block includes a set of memory cells (“cells”). A memory cell is an electronic circuit that stores information. Depending on the cell type, a memory cell can store one or more bits of information, and its charge level can define various logic states that correlate to the number of bits being stored. The logic states can be represented by binary values, such as “0” and “1”, or combinations of such values. Each block and sub-block can be selectively accessed by memory access operations (e.g., read, write, erase operations).

Memory cells can be formed on a silicon wafer in an array of columns (also hereinafter referred to as “bitlines”) and rows (also hereinafter referred to as wordlines). A wordline refers to one or more rows of memory cells of a memory device that are used with one or more bitlines to generate the address of the memory cells. The intersection of a bitline and wordline defines the address of the memory cell.

A block refers to a unit of the memory device used to store data and can include a group of memory cells, a word line group, a word line, or individual memory cells. Each block can include a number of sub-blocks, where each sub-block is defined by an associated pillar (e.g., a vertical conductive trace) extending from a shared bitline. Memory pages (also referred to herein as “pages”) store one or more bits of binary data corresponding to data received from the host system. To achieve high density, a string of memory cells in a non-volatile memory device can be constructed to include a number of memory cells at least partially surrounding a pillar of poly-silicon channel material (i.e., a channel region). The memory cells can be coupled to access lines (i.e., wordlines) so as to form an array of strings in a block of memory (e.g., a memory array). The compact nature of certain non-volatile memory devices, such as 3D flash NAND memory, means that word lines are common to many memory cells within a block of memory. Some memory devices use certain types of memory cells, such as triple-level cell (TLC) or quadruple level cell (QLC), which store three bits of data in each memory cell, which make it affordable to move more applications from legacy hard disk drives to newer memory sub-systems, such as NAND solid-state drives (SSDs).

Memory access operations performed on a memory device can utilize certain values of memory configuration parameters, which can include, for example, read offset values, valley width voltage values, read refresh thresholds, etc. Improper values of memory configuration parameters can degrade memory device performance. For example, improper values of memory configuration parameters can cause the memory controller of a memory sub-system to perform folding operations and/or deep check operations more often than might be necessary to maintain data integrity of the memory device. Improper values of memory configuration parameters can degrade the threshold voltage (VT) of memory cells in the memory device, and thus reduce the data storage reliability of the impacted memory cells. Memory devices can have one or more values for one or more performance metrics that can impact the memory sub-system. Memory devices with proper values of memory configuration parameters can enable the memory device to satisfy a corresponding threshold condition, and thus can perform better than memory devices with improper values of memory configuration parameters.

Some examples of memory configuration parameters can include a bit error rate (BER), a residual bit error rate (RBER), a folding threshold, a forgiveness threshold, an error trigger rate, a read refresh rate, a quality of service (QOS) threshold condition, a block family error avoidance (BFEA) bin pointers, a deep-check threshold, a read level offset, a read disturb handing (RDH) window, or a temperature compensation value.

Bit error rate (BER) can refer to a ratio of a number of bits in error of a data vector divided by a total number of bits for the given data vector. Residual bit error rate (RBER) can correspond to a number of bit errors per unit of time that the data stored at the block includes an error.

“Folding” refers to a media management operation that can be performed if a wordline error rate exceeds a threshold value (e.g., a folding threshold), to relocate the data stored on the wordline. Folding the data stored at the wordline can include writing the data stored at the wordline or block to another block to refresh the data stored on the memory device.

A forgiveness threshold can be defined for a memory device or group of wordlines, based on an occurrence counter that counts occurrences of the aggregate value of one of data state metrics failing to satisfy their respective threshold condition (i.e., BER threshold condition, RBER threshold condition, etc.). For example, responsive to determining that the BER count does not satisfy a pre-determined threshold value M, the memory controller can increment, for the group of wordlines, an occurrence counter that counts occurrences of the BER count failing to satisfy the value M. Each instance of the BER count failing to satisfy the threshold condition can be referred to as a forgiven state. The memory device can have a forgiveness threshold, that when satisfied by the occurrence count (i.e., forgiven state count), causes one or more memory access operations to be performed on the memory device.

The error trigger rate is an estimate of a frequency of implementing an error recovery mechanism, and can estimate a projection of the error measure for various conditions or situations. For example, the trigger rate can be based on a number of error correction code (ECC) bits in error associated with the error recovery mechanism, a rate of the codewords, or a combination thereof.

Since voltage distributions can shift over time, a read operation performed at a certain interval (e.g., the read refresh rate) can refresh the data stored in a set of cells, reduce threshold voltage shift, and maintain respective voltage levels at or near initially programmed values.

Quality of service (QOS) can describe a distribution of operational latencies within a system. QoS control can be used to prioritize operations such as user-initiated operations (e.g., read and/or write requests) and internal maintenance operations. QoS control can include a QoS threshold condition, that when satisfied by a memory access operation, can cause the QoS control operation to be performed.

Block family error avoidance BFEA techniques can be used by a memory device to compensate for memory cell voltage drift over time. BFEA techniques group blocks programmed under similar conditions (often time and temperature) into bins. The information on which block(s) correspond to which bin(s) can be stored as BFEA bin pointers.

A deep check can be performed on a memory device when the data integrity of the memory device is in question. The data integrity of the memory device can be questioned when an error count for a set of cells exceeds a deep check threshold. A deep check is performed with a continuous read level calibration (cRLC) using a read sample offset (RSO) operation. Multiple reads can be performed at varying offsets, generally referred to as left, right, and center strobes, to read the data of the memory device. The left and right strobes can be placed at a fixed equidistant offset relative to the center strobe, and can correspond to the valley shape. Each read is of the same data and returns an error count associated with the read data.

Read level offsets are used for memory access operations on a set of cells for a voltage distribution that has shifted from an initial programming position. As noted above, temperature can contribute to voltage distribution shifts. To compensate for temperature based voltage distribution shifts, a temperature compensation value can be used in memory access operations.

Read disturb is a phenomenon where reading data from a memory cell can cause the threshold voltage of unread memory cells in the same block to shift to a higher value. For example, when repeated read operations performed on a wordline, data stored at adjacent wordlines of the memory sub-system can become corrupted at the memory cell(s) of the adjacent wordlines. This can result in a higher error rate of the data stored at the wordline and adjacent wordlines. A read disturb handling (RDH) operation can be performed to address read disturb, and the window size of the RDH operation can determine the speed and accuracy of the RDH operation.

Proper values of the above examples of memory configuration parameters can allow memory access operations performed on the memory device to satisfy a corresponding threshold condition for the memory access operation. Similarly, improper values of memory configuration parameters can prevent memory access operations performed on the memory device from satisfying the corresponding threshold condition. However, determining proper values of memory configuration parameters during production of the memory device can be time- and resource-intensive. The values of memory configuration parameters can depend on, for example, memory device trim parameters, memory device physical structure, per-cell memory densities of a memory device, physical circuit layouts of the memory device, etc. Thus, a change to underlying factors on which the values of memory configuration parameters are dependent can require calculating new values of memory configuration parameters. For example, if memory device trim parameters are altered, it is likely that new values of memory configuration parameters need to be calculated to align with the altered trim parameters. Determining the values of memory configuration parameters can include measuring how the memory device responds to certain tests. Each test can be part of a measurement phase in the iterative process to determine the values of memory configuration parameters. In some embodiments, phases can be performed in parallel. Some phases (i.e., tests, or groups of tests) can last weeks and require consistent attention from engineers. The overall time it takes to determine the values of memory configuration parameters can slow the development cycle of a memory device or memory sub-system. Additionally, because of the multiple variables in a production and design process of a memory device, engineers designing and assisting with manufacturing the memory device can have a limited understanding of the interaction between changes to a memory device design, and the values of memory configuration parameters.

A trim can refer to a digital value that is used for a circuit, such as a register, that is converted into an analog voltage value. For example, the read level threshold trims can be programmed into a trim register, which produces a read level threshold voltage used to read data from a memory cell. Trim parameters can include the calculation or mathematical transformation between the digital values and the analog voltage values. For example, trims can correspond to initial, or intended voltages of voltage distributions. Trims apply across the memory device and can be modified throughout the life of the memory device according to device conditions. Trim parameters control how memory access operations are performed on NAND. For example, for a programming operation, the trim parameters can include the programming voltage, the programming pattern, and the duration of the programming pulse. Memory configuration parameters can be compensation values when physical characteristics or operating conditions of the memory device degrade. Memory configuration parameters can be used to control memory maintenance operations and/or background operations. Memory configuration parameters can also be use in connection with trim parameters to perform memory access operations. For example, the trim can be a read level for a given voltage distribution, and a memory configuration parameter can be a read level offset due to voltage migration since initial programming. In another example, the trim can be a read level for a given voltage distribution, and the memory configuration parameter can be a voltage distribution width for the given voltage distribution.

After determining the values of memory configuration parameters, a memory validation process may be performed to ensure that the memory device can meet the design requirements (i.e., the memory device performance metrics). If memory access operations performed on the memory device do not satisfy the corresponding threshold conditions, the values of memory configuration parameters can be re-determined and re-validated. In some embodiments, re-determining the values of memory configuration parameters can be less intensive than determining the initial values of memory configuration parameters. If, upon re-validation (including repeated re-determination and re-validation), the memory device does not satisfy the threshold conditions on which the performance metrics are based, other aspects of the memory device can be adjusted. In many embodiments, adjusting other aspects of the memory device can require completely new values of the memory configuration parameters to be determined.

Aspects of the present disclosure address the above and other deficiencies by utilizing a trainable model to predict values of memory configuration parameters for memory devices based on machine learning techniques. The trainable model can use for example, linear regression, support vector machine (SVM) regression, supervised machine learning, a neural network (e.g., an artificial neural network), etc. The trainable model can be trained using historical data recorded for previously manufactured memory devices as input and target outputs (e.g., such as historical values of memory configuration parameters as inputs, and historical values of memory performance metrics as target outputs). Historical data for previously manufactured memory devices can include data measured and verified by hand, and/or prediction data from either a previous iteration of the trainable model on the current memory device, or a previous instance of the trainable model with regards to a previously manufactured memory device. In certain embodiments, historical values of memory configuration parameters can be provided as a training input for the trainable model, with historical values of performance metrics as a target output.

Advantages of the present disclosure include improving the memory device performance and reliability. By predicting proper memory configuration parameter values for a memory device, overall development time for new memory devices can be reduced. Additionally, in some embodiments, the trainable model can identify a connection between the model inputs and the outputs (e.g., such as a mathematical transformation and accompanying confidence level) that can be used to further reduce development time, and increase memory device performance and reliability.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs, or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system 110 includes a memory configuration parameters component 113 that can include memory configuration parameters generated by the trainable model (not pictured). In some embodiments, the memory sub-system controller 115 includes at least a portion of the memory configuration parameters component 113. In some embodiments, the memory configuration parameters component 113 is part of the host system 120, an application, or an operating system. In other embodiments, local media controller 135 includes at least a portion of memory configuration parameters component 113.

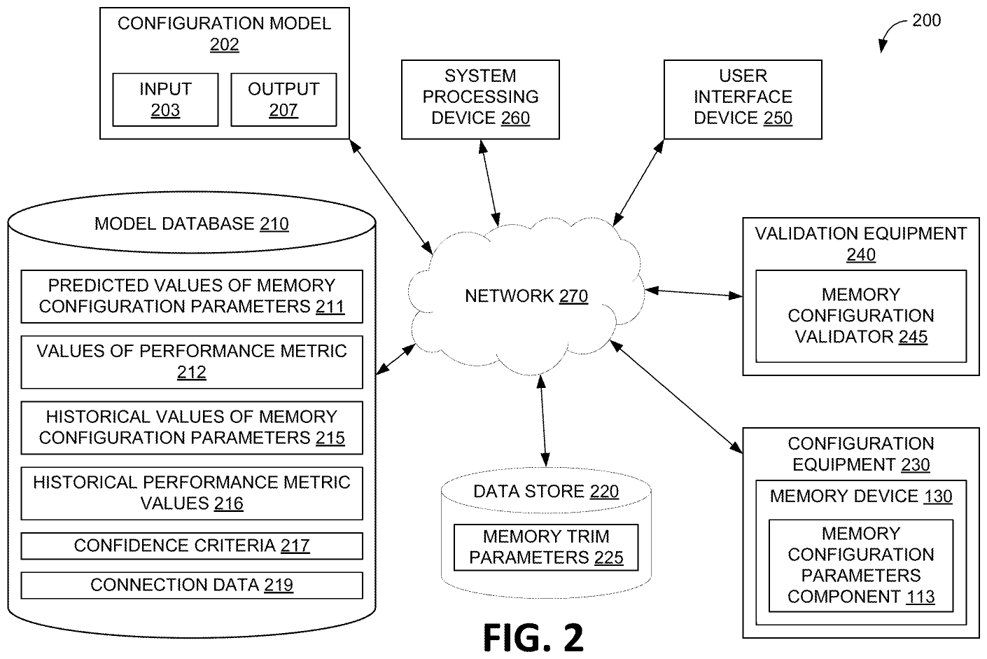

FIG. 2 illustrates an example production environment 200 associated with producing a memory device, in accordance with some embodiments of the present disclosure. Production environment 200 can include configuration model 202, model database 210, data store 220, configuration equipment 230, memory configuration validator 240, user interface device 250, and system processing device 260. In some embodiments, each of configuration model 202, model database 210, data store 220, configuration equipment 230, memory configuration validator 240, user interface device 250, and system processing device 260 can be connected via a network 270. Production environment 200 can include (or refer to) a manufacturing system and/or production system.

During production of a memory device, values of memory configuration parameters can be determined in order to test whether the memory device can satisfy various threshold conditions on which one or more performance metrics are based. Configuration model 202 can be used to predict values of memory configuration parameters for memory device 130. Configuration model 202 can be implemented by user interface device 250, system processing device 260, or another component of production environment 200 connected to network 270 (not shown). Configuration model 202 can be composed of a single level of linear of non-linear operations (e.g., linear/SVM regression) and/or may be a neural network. Once generated, the configuration model 202 can be stored in, for example, model database 210, user interface device 250, system processing device 260, or another component of production environment 200 connected to network 270 (not shown).

Configuration model 202 can be trained using supervised learning techniques which involves feeding a training dataset consisting of labeled inputs 203 through configuration model 202, observing the model outputs 207, defining an error (by measuring the difference between the outputs and the label values), and adjusting parameters of configuration model 202 to minimize the error. With respect to artificial neural networks, techniques such as deep gradient descent and backpropagation can be used to tune the weights of the network across all its layers and nodes such that the error is minimized. Repeating this and similar processes across the labeled inputs 203 in the training dataset yields a configuration model 202 that can produce correct output 207 when presented with inputs 203 that are different than the training inputs 203 present in the training dataset. A training dataset can be formed by hundreds, thousands, tens of thousands, hundreds of thousands or more measurement data, performance data, and/or design requirements (e.g., memory configuration parameter values, memory access operation threshold condition values, performance metric values, etc.).

The output 207 of configuration model 202 can include one or more predicted values of memory configuration parameters, values of performance metrics, etc. Processing logic determines an error (i.e., a classification error) based on the differences between the output 207 (e.g., predictions) of configuration model 202 and target labels associated with the input 203 training data. Processing logic can adjust configuration model 202 constraints (e.g., internal model parameters) based on the determined error. For example, in an artificial neural network, an error delta can be determined for each node of the artificial neural network, and based on the error delta, the artificial neural network can adjust one or more parameters for one or more nodes (e.g., the weights for one or more inputs of a node).

After one or more rounds of training, processing logic can determine whether a terminating criterion has been met. A terminating criterion can be a target level of accuracy, a target number of processed inputs 203 from the training dataset, a target amount of change to parameters over one or more previous data points a combination thereof and/or other criteria. In some embodiments, the terminating criteria is met when at least a minimum number of data points have been processed and at least a threshold of accuracy is achieved. In some embodiments, the terminating criterion is met if the accuracy of configuration model 202 has stopped improving. If the terminating criterion has not been met, additional training is performed. If the terminating criterion has been met, training can be complete. In some embodiments, once configuration model 202 is trained, a reserved portion of the training dataset can be used to test the configuration model 202.

Configuration model 202 can be trained to processes the input 203 to generate the output 207. To effectuate the training, processing logic can input the training dataset into an initialized configuration model 202. Training can be performed by inputting one or more of the memory configuration parameters into configuration model 202 one at a time. For example, configuration model 202 can be a regression model, a neural network, a decision tree, and/or a rule engine evaluating a set of rules.

Configuration model 202 can be a regression model, including a linear regression model, an SVM regression model, etc. A linear regression model can describe a line expressed as seen in Formula 1 below which can be drawn to match various data points (e.g., minimize the distance between a set of datapoints plotted with respect to multiple dimensions and some line expressed as seen in Formula 1). In Formula 1, the x value(s) represent each selected feature, the c value(s) represent corresponding coefficients, the BO value represents the intercept value, and y represents the label value:

$$y = {β}_{0} + {c}_{1} {x}_{1} + {c}_{2} {x}_{2} + {c}_{3} {x}_{3} + \qquad Formula 1$$

A SVM regression model can also be similar to Formula 1 seen above, however, instead of minimizing error between real and predicted values (as in linear regression), the SVM regression model can be used to fit a best line within a threshold value. Thus, it can be said that an SVM regression model maximizes the distance between the line, and two boundary lines (e.g., a positive and negative boundary offset with a magnitude equal to the threshold value), which can be expressed as seen in Formula 2 below, where the x value(s) represent each selected feature, the c value(s) represent corresponding coefficients, the β₀ value represents the intercept value, y represents the label value, and α₀ represents the threshold value:

$$- {α}_{0} < y - {β}_{0} + {c}_{1} {x}_{1} + {c}_{2} {x}_{2} + {c}_{3} {x}_{3} + … < {α}_{0} \qquad Formula 2$$

Configuration model 202 can be an artificial neural network. Artificial neural networks generally include a feature representation component with a classifier or regression layers that map features to a desired output space. Deep learning is a class of machine learning algorithms that use a cascade of multiple layers of nonlinear processing units for feature extraction and transformation, where each successive layer uses the output from the previous layer as input. Deep neural networks include a hierarchy of layers, where the different layers learn different levels of representations that correspond to different levels of abstraction. In deep learning, each level learns to transform its input data into slightly more abstract and composite representation. Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output.

An artificial neural network can include an input layer that consists of values in a data point. The next layer is called a hidden layer, and nodes at the hidden layer each receive one or more of the input values. Each node contains weights to apply to the input values. Each node therefore essentially inputs the input values into a multivariate function (e.g., a non-linear mathematical transformation) to produce an output value. A next layer can be another hidden layer or an output layer. In either case, the nodes at the next layer receive the output values from the nodes at the previous layer, and each node applies weights to those values and then generates its own output value. This can be performed at each layer. A final layer is the output layer, where there is one node for each class, prediction and/or output that configuration model 202 can produce.

Configuration model 202 can be a decision tree model. A decision tree can be a flow chart like structure stored on a memory device that can be used to classify portions of labeled inputs. A decision tree model can include branch nodes and leaf nodes. Each branch node specifies a feature that includes a test to be carried out on the branch node. For example, each internal (or non-leaf) node denotes a test on a labeled input, and each branch represents an outcome of the test. At each branching node, the branch indicates there is a test in this node, and to proceed according to the outcome of this test. If there are no more tests, the tree can arrive at a leaf node. A leaf node will not include a test, but rather can predict the outcome as taken or not taken. For example, assume the feature vector X=[0, −1, −1, −1, −1]. The first branching node in the decision tree may include a test, such as “Is the first element of vector X greater than or equal to zero?” If it is greater than or equal to zero, then outcome is predicted as “taken.” This is a leaf node because there are no more tests, and the outcome is directly predicted. If first element of X is smaller than zero, then another branching node can test if the second element of X is greater than 0. This test is called a branch node in the tree and may continue until no more tests are required. Leaf nodes (i.e., outputs) can include branch path data, indicating which branches were selected along the decision tree between the root (i.e., the input) and the leaf node (i.e., the output).

The branch node at the root of the decision tree can be the earliest branch of the correlated branches in the branch history. Each leaf node is a possible outcome from a connected branch. Leaf nodes can also contain additional information about the represented classifications of parts of labeled inputs, such as a branch confidence score that measures a confidence in the determined classification (e.g., the likelihood of the classification being accurate in the direction that the branch will be taken). For example, the branch confidence score can be a value ranging from 0 to 1, where a score of 0 indicates a very low confidence (e.g., the indication value of the represented classification is very low) and a score of 1 indicates a very high confidence (e.g., the represented classification is almost certainly accurate).

Configuration model 202 can be a rule engine evaluating a set of rules. A rule engine can apply one or more predefined and/or dynamically configurable rules to labeled inputs. For example, a selection rule can define a logical condition and an action to be performed if the logical condition is evaluated as true. The logical condition can comprise one or more value ranges or target values for respective labeled inputs. Should the labeled inputs satisfy the condition (e.g., by the respective labeled inputs falling within predefined value ranges, and/or matching respective target values), the action specified by the rule is performed.

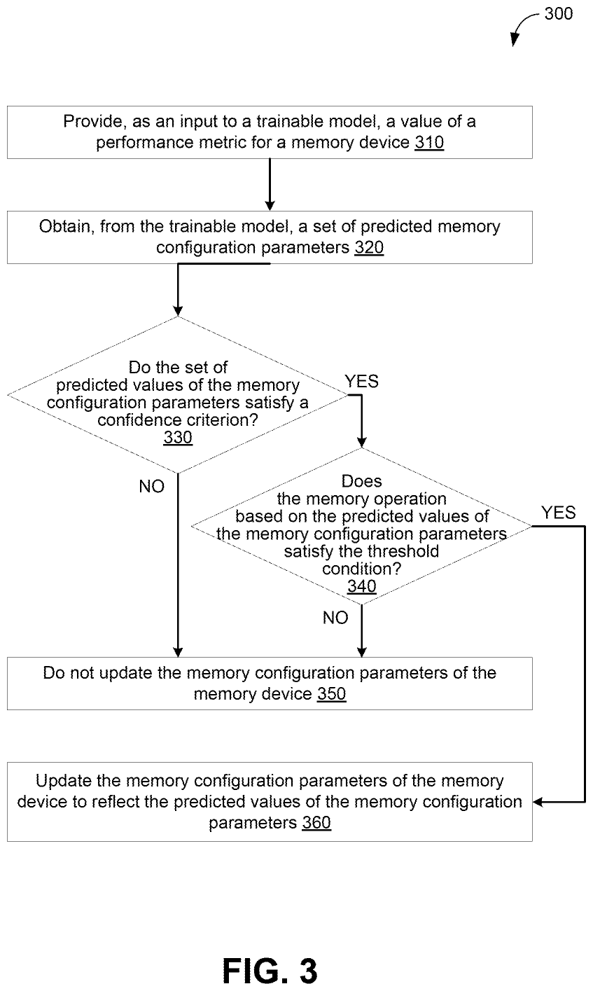

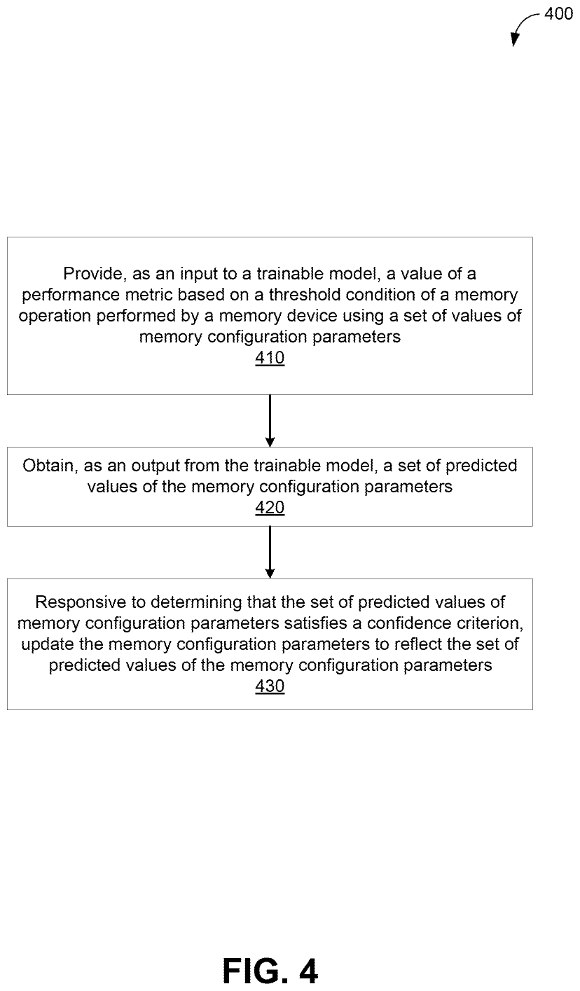

In the illustrative example, configuration model 202 can include training inputs (i.e., input 203) and corresponding target outputs (i.e., output 207). In some embodiments, configuration trainable model can find patterns in the training data that map the training input 203 to the target output 207 (i.e., the value to be predicted). Configuration model 202 can receive, as input 203, a value of performance metric 212 for memory device 130. Configuration model 202 can produce, as output 207, a set of predicted values of memory configuration parameters 211. The value of performance metric 212 can be based on a threshold condition of a memory access operation performed by a memory device using a set of memory configuration parameters. For example, a read operation can be performed on a memory device by using a value of a memory configuration parameter such as a read level offset value. The threshold condition of read operation might be an expected error rate value, and can be satisfied when the error rate of the read operation is below the expected error rate value. Output 207 can also include an indication of whether the predicted values of memory configuration parameters 211 satisfy confidence criteria 217. In some embodiments, output 207 generated during use of configuration model 202 can be used to train the configuration model 202 (e.g., such as by using output 207 as a future input 203, or deriving an input 203 from previous output 207). Further details regarding operation of configuration model 202 are described blow with reference to FIG. 3 and FIG. 4.

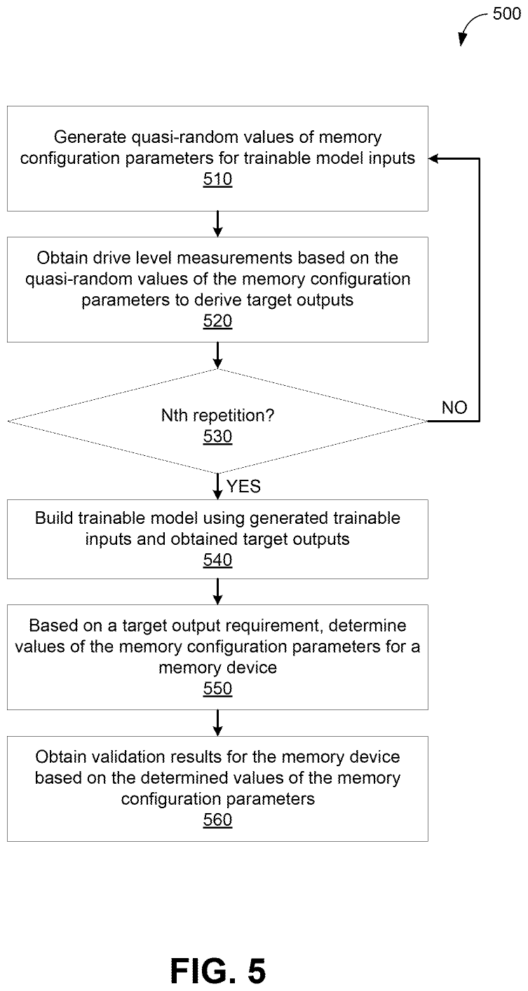

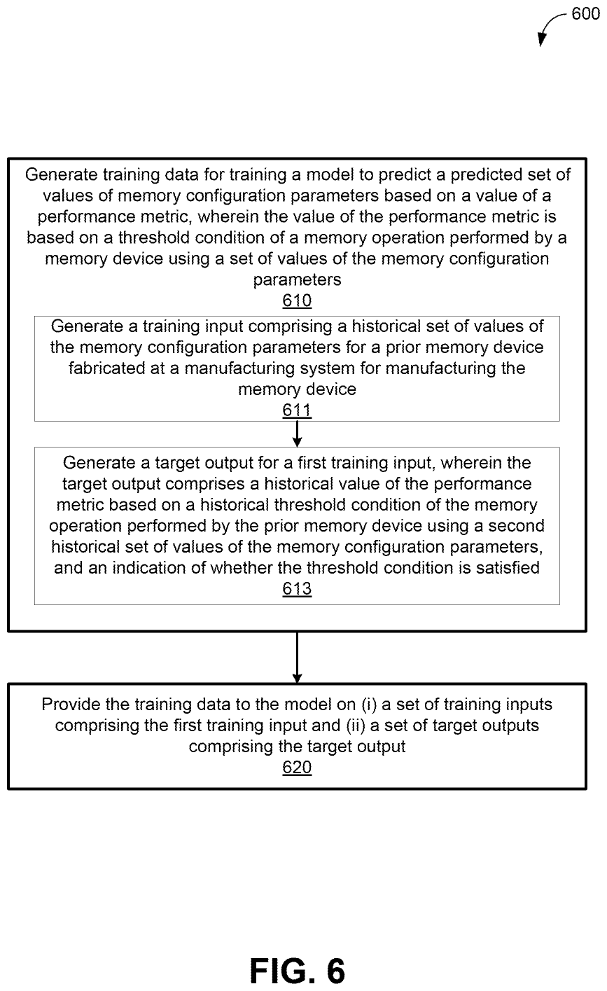

In the illustrative example, to train the configuration model 202, historical performance metric values 216 can be used as input 203 to generate output 207. Output 207 can include predicted values of the memory configuration parameters 211. The predicted values of memory configuration parameters 211 can be the final values of the memory configuration parameters for a memory device such as memory device 130, or the predicted values of memory configuration parameters 211 can be intermediate values that are used to test the memory device 130. In some embodiments, predicted values of memory configuration parameters 211 can be used to determine the design changes required for memory device 130. Additional data collected from memory device 130 can be used to construct configuration model 202. For example, data obtained from data store 220, configuration equipment 230, memory configuration validator 240, and/or indications of satisfying the confidence criteria 217, etc. Further details regarding training the configuration model 202 are described below with reference to FIG. 5 and FIG. 6.

Model database 210 can include predicted values of memory configuration parameters 211 and values of performance metric 212 for a memory device in configuration equipment 230, such as memory device 130. Model database 210 can include historical values of memory configuration parameters 215 and historical performance metric values 216 for memory devices previously processed in configuration equipment 230. In some embodiments, historical values of memory configuration parameters 215 and historical performance metric values 216 can be from memory devices previously processed outside of configuration equipment 230 (i.e., prior memory devices). In some embodiments, historical values of memory configuration parameters 215 and historical performance metric values 216 can be partially user or computer generated. Model database 210 can include confidence criteria 217. Confidence criteria 217 can include threshold values for predicting predicted values of memory configuration parameters 211 based on values of performance metric 212.

Data store 220 can include values of memory trim parameters 225. Memory trim parameters 225 can include values of trim parameters for a current memory device (i.e., memory device 130 as shown). Memory trim parameters 225 can include historical values of trim parameters for prior memory devices (not shown). In some embodiments, data store 220 can also include values of other parameters for memory device 130 and/or historical values of parameters for prior memory devices. Historical values of memory configuration parameters 215 can be extracted from data in data store 220. In some embodiments, historical values of memory configuration parameters 215 can be partially extracted from memory trim parameters 225.

Configuration equipment 230 can include a memory device such as memory device 130. In some embodiments, configuration equipment 230 can include model database 210, data store 220, memory configuration validator 240, and/or system processing device 260. As described above with respect to FIG. 1, memory device 130 can include memory configuration parameters component 113. Configuration equipment 230 can store predicted values of memory configuration parameters 211 on memory configuration parameters component 113. In some embodiments, system processing device 260 can instruct production equipment to store predicted values of memory configuration parameters 211 on memory configuration parameters component 113.

Memory configuration validator 240 can perform known validation checks (e.g., stress tests, read operation tests, write tests, etc.) on memory device 130 to confirm that memory configuration parameters stored on memory configuration parameters component 113 (e.g., predicted values of memory configuration parameters 211) satisfy the threshold condition on which the performance metrics are based. For example, memory configuration validator 240 can: stress test blocks at beginning of life (BOL), middle of life (MOL), and end of life (EOL); validate block family error avoidance (BFEA) bins; perform high temperature direct reads (HTDR); perform latent reads; test NAND detect erased page (NDEP); validate a partial block lookup table; validate read disturb and read disturb handling (RDH); validate temperature compensation; and validate program erase cycle (P/E cycle) count. Through testing, memory configuration validator 240 can determine whether the predicted values of memory configuration parameters 211 stored on memory configuration parameters component 113 satisfy the threshold conditions on which the values of performance metric 212 are based. Values of performance metric 212 can be associated with corresponding validation checks. In some embodiments, confidence criteria 217 can be based on results of validation checks performed by memory configuration validator 240. In some embodiments, memory configuration validator 240 can determine whether memory trim parameters for memory device 130 satisfy trim performance metrics.

User interface device 250 can issue instructions to system processing device 260. In some embodiments, user interface device 250 can issue instructions directly to production environment 200. User interface device 250 can receive data from production environment 200. In some embodiments, user interface device 250 can include model database 210, data store 220 and/or system processing device 260. User interface device 250 can display data stored in model database 210, including predicted values of memory configuration parameters 211, values of performance metric 212, historical values of memory configuration parameters 215, historical performance metric values 216, and/or confidence criteria 217. In some embodiments, user interface device 250 can modify values of performance metric 212, historical values of memory configuration parameters 215, historical performance metric values 216, and/or confidence criteria 217.

System processing device 260 can issue instructions to production environment 200. In some embodiments, system processing device 260 includes configuration model 202. System processing device 260 can received instructions from configuration equipment 230 and memory configuration validator 240. In some embodiments, system processing device can issue instructions on behalf of configuration equipment 230 and/or memory configuration validator 240 to production environment 200.

Network 270 connects components of production environment 200. Network 270 represents a network internal to production environment 200. In some embodiments, network 270 can be connected to one or more networks external to production environment 200 (not shown). In some embodiments, network 270 can connect to a server device.

FIG. 3 is a flow diagram of an example method 300 for using a trainable model to predict values of memory configuration parameters, in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the configuration model 202 via the system processing device 260 of FIG. 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 310, the processing device implementing the method 300 provides, as an input to a trainable model, a performance metric for a memory device. In some embodiments, the processing device can be a production environment processing device, such as system processing device 260 as described with respect to FIG. 2. The performance metric can be based on a design requirement for the memory device, or for a family that includes the memory device (i.e., a product family). The performance metric can depend on one or more device characteristics. For example, a memory device can have a certain slow charge loss (SCL) performance metric. The slow charge loss performance metric of the memory device can depend on multiple characteristics, including, for example, read operations, read refresh rates, and memory per-cell densities. Read operations, and read refresh rates are dependent on values of memory configuration parameters. In some embodiments, read level voltages and read refresh rates can be stored as corresponding values of memory configuration parameters.

At operation 320, the processing device obtains one or more outputs from the trainable model. Outputs from the trainable model can include, for example, numerical indicators, comparative values, tables, maps, or graphs. In some embodiments, the trainable model can be trained to produce an output of predicted values of the memory configuration parameters with no additional post-processing. In some embodiments, predicted values of the memory configuration parameters can be derived (i.e., extracted) from the output of the trainable model. The processing device can discard extracted information that is part of the predicted values of the memory configuration parameters. In some embodiments, the processing device can use extracted information from the model outputs as part of the model input (e.g., for recursive training).

At operation 330, the processing device determines whether the set of predicted values of the memory configuration parameters satisfy a confidence criterion. The confidence criterion can reflect an estimated likelihood that the memory access operation based on the predicted values of the memory configuration parameters will satisfy the threshold condition of the memory access operation (i.e., the threshold condition on which the performance metric is based). The determination of satisfying the confidence criterion can be a binary (i.e., yes/no) value. The confidence criterion can be determined during pre-production of the memory device. Confidence criterion can be based on an importance assigned to the memory access operation (in comparison to an “importance” of other memory access operations), or similar metrics.

At operation 340, responsive to satisfying the operation 350, the processing device determines whether the memory access operation based on the predicted values of the memory configuration parameters satisfies the threshold condition. Memory operations implemented by the memory controller (such as memory sub-system controller 115, or local media controller 135 as described with respect to FIG. 1) can have associated threshold conditions based on memory device design requirements. For example, the memory device can have an error threshold associated with a read operation. The read operation can be said to satisfy the error threshold when the number of errors from the read operation remains below the error threshold. The number of errors from the read operation can be based on the values of the memory configuration parameters that the memory controller uses to perform the read operation. If a memory access operation based on the predicted values of the memory configuration parameters satisfies the corresponding threshold condition, it can be said that the predicted values of the memory configuration parameters are proper. In some embodiments, the memory access operation based on predicted values of the memory configuration parameters can perform better than a memory access operation based on parameters derived without using a trainable model (such as configuration model 202 as described with respect to FIG. 2). In some embodiments, the processing device can skip operation 340, and if the processing device determines that operation 330 is satisfied, the processing device can proceed to operation 360.

In some embodiments, the processing device can determine, for the predicted values of the memory configuration parameters, a confidence level that the memory access operation based on the predicted values of the memory configuration parameters satisfies a threshold condition. In some embodiments, the processing device can use extraneous extracted information from the model output to determine the confidence level. that the predicted values of the memory configuration parameters will enable the memory device to satisfy the performance requirement. The confidence level can be predetermined during pre-production of the memory device, and can relate to memory device design characteristics. In some embodiments, the confidence level can be based on a memory device type or memory device product family.

At operation 350, responsive to failing either operation 330 or operation 340, the processing device does not update the memory configuration parameters of the memory device. The processing device can save the predicted values of the memory configuration parameters for memory access operations that do not satisfy the threshold condition in a data structure of the production environment associated with producing the memory device. In some embodiments, values of memory configuration parameters that do not allow a memory access operation to satisfy the threshold condition can be used to generate training input for the trainable model.

At operation 360, responsive to satisfying the operation 340, the processing device updates the memory configuration parameters of the memory device to reflect the predicted values of the memory configuration parameters. In some embodiments, if predicted values of the memory configuration parameters satisfy operation 330, but fail operation 340, the processing device may still elect to proceed to operation 360 instead of operation 350. For example, when performing iterative testing, the processing device can update memory configuration parameters of the memory device with non-final memory configuration parameters. Additionally, in some embodiments, the processing device, with aid from the trainable model, can determine that there are no values of the memory configuration parameters that will allow the memory access operation(s) to satisfy the threshold condition, and can update the memory device to reflect the best values of the memory configuration parameters that were predicted (i.e., the predicted values of the memory configuration parameters for the memory access operation that were closest to satisfying the threshold condition).

FIG. 4 is a flow diagram of an example method 400 for using a trainable model to predict values of the memory configuration parameters, in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the configuration model 202 via the system processing device 260 of FIG. 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, the processing device implementing the method 400 provides, as an input to a trainable model, a value of a performance metric based on a threshold condition of a memory access operation performed by a memory device using a set of values of memory configuration parameters. The trainable model can be a trainable model such as configuration model 202 as described with respect to FIG. 2. As described above, the trainable model can be a supervised trainable model such as, for example, a linear regression trainable model, a support vector machine (SVM) regression trainable model, or a neural network trainable model. In some embodiments, the processing device can be a production environment processing device, such as system processing device 260 as described with respect to FIG. 2. In some embodiments, a memory device can be part of a memory sub-system such as memory sub-system 110 as described with respect to FIG. 1. In some embodiments, the memory sub-system can have a system performance metric, which can be satisfied at least in part when the performance metric for the memory device is satisfied.

As described above, the performance metric can be a design requirement for the memory device, or for a family that includes the memory device (i.e., a product family). The value of the performance metric can depend on one or more device characteristics, including one or more threshold conditions. For example, a memory device can have a certain slow charge loss (SCL) performance metric, and the slow charge loss performance metric can depend on characteristics, such as read operations, read refresh rates, and memory per-cell densities. Read operations, and read refresh rates are dependent on values of memory configuration parameters. Thus, the performance metric can be based on one or more threshold conditions of respective memory access operations. Memory operations can satisfy respective threshold conditions on which the performance metric can be based with proper values of the memory configuration parameters. Thus, proper values of the memory configuration parameters can impact whether the memory device satisfies a threshold condition.

In some embodiments, read level voltages and read refresh rates can be stored as corresponding values of memory configuration parameters. The memory configuration parameters can correspond to and/or include, for example, BER, RBER, a folding threshold, an error trigger rate, a read refresh rate, a QoS threshold condition, a BFEA bin pointer, a deep-check threshold, a read level offset, a RDH window, a temperature compensation value, etc.

At operation 420, the processing device obtains, as an output from the trainable model, a set of predicted values of the memory configuration parameters. Outputs from the trainable model can also include, for example, numerical indicators, comparative values, tables, maps, graphs, etc. Outputs can be saved in a data structure associated with the production environment for further processing. In some embodiments, the outputs can include indications of model input values. In some embodiments, the outputs can include transformational data (i.e., referential data that corresponds to the transformation between the input value and an output value).

The processing device can extract the set of predicted values of the memory configuration parameters from the output of the trainable model. The output of the trainable model can indicate a relationship between the input(s) to- and the output(s) from- the trainable model. In some embodiments, the relationship between the input(s) and output(s) of the trainable model can be represented with a mathematical approximation and/or one or more numerical indicators. In some embodiments, the trainable model can indicate which input(s) affect which output(s). For example, even without a mathematical approximation of a relationship between input(s) and output(s) of the trainable model, the trainable model can indicate that a certain input(s) is likely to affect a certain output(s). In some embodiments, the processing device can provide the output(s) of the trainable model to a client device of a production environment, such as user interface device 250 and production environment 200 as described with respect to FIG. 2 respectively. In some embodiments, the trainable model can be trained to produce sets of predicted values of memory configuration parameters with no additional post-processing. In some embodiments, a set of predicted values of memory configuration parameters can be derived (i.e., extracted) from the output of the trainable model. The processing device can discard extracted data that is required to predict the values of memory configuration parameters. In some embodiments, the processing device can use extracted data from the model outputs as a part of an input to the trainable model (e.g., for recursive training).

Memory access operations implemented by the memory controller (such as memory sub-system controller 115, or local media controller 135 as described with respect to FIG. 1) can have corresponding threshold conditions based on memory device design requirements. For example, the memory device can have an error threshold associated with a read operation. The read operation can be said to satisfy the error threshold when the number of errors from the read operation remains below the error threshold. The number of errors from the read operation can be based on the values of the memory configuration parameters that the memory controller uses to perform the read operation. If a memory access operation based on the predicted values of the memory configuration parameters satisfies the corresponding threshold condition, it can be said that the values of the memory configuration parameters are proper. The memory access operation can be based on the predicted values of the memory configuration parameters. In some embodiments, the memory access operation based on predicted values of memory configuration parameters 211 can perform better than a memory access operation based on values of memory configuration parameters derived without using a trainable model (such as configuration model 202 as described with respect to FIG. 2).

At operation 430, responsive to determining that the set of predicted values of the memory configuration parameters satisfies a confidence criterion, the processing device updates the memory configuration parameters to reflect the set of predicted values of the memory configuration parameters. The confidence criterion can be determined during pre-production of the memory device. Confidence criterion can be based on an importance assigned to the memory access operation (in comparison to an “importance” of other memory access operations), or similar metrics.

The processing device can generate a confidence indicator that reflects whether the set of predicted values of the memory configuration parameters satisfies the confidence criterion. In some embodiments, the processing device can transmit the confidence indicator to the client device (e.g., system processing device 260 as described with respect to FIG. 2). The confidence indicator can reflect an estimated likelihood that the memory access operation will satisfy the corresponding threshold condition. In some embodiments, the confidence indicator can be a binary (i.e., yes/no) value, or a percentage. Confidence criterion and calculations to determine the confidence indicator with respect to the confidence criterion can be set by a production system, and can depend on manufacturing techniques, design requirements, memory device characteristics, etc. In some embodiments, the confidence indicator can be based on a memory device type or memory device product family.

The processing device can transmit an instruction to a system processing device of the production environment (such as system processing device 260 as described with respect to FIG. 2) to initiate a validation of the memory device based on the updated values of the memory configuration parameters. In some embodiments, validation of the values of the memory configuration parameters can be performed by the system processing device. In some embodiments, the validation process, or a part of the validation process can be integrated into the trainable model.

To update the memory configuration parameters of a memory device, the processing device can update one or more entries of a data structure accessible to the memory sub-system that includes the memory device. The processing device can save the predicted values of the memory configuration parameters that do not satisfy the confidence criterion in a data structure of the production environment. In some embodiments, the values of the memory configuration parameters that do not allow a memory access operation to satisfy the threshold condition can be used to generate future training input for the trainable model. In some embodiments, the processing device, with aid from the trainable model, can determine that there are no values of the memory configuration parameters that will allow the memory access operation(s) to satisfy the threshold condition, and can update the memory configuration parameters of the memory device to reflect the best values of the memory configuration parameters that were predicted (i.e., the memory configuration parameters for the memory access operation that was closest to satisfying the threshold condition, or the predicted values of the memory configuration parameters were closest to satisfying the confidence criterion).

FIG. 5 is a flow diagram of an example method 500 for training a trainable model to predict the values of memory configuration parameters, in accordance with some embodiments of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the configuration model 202 via the system processing device 260 of FIG. 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 510, the processing device implementing the method 500 generates quasi-random values of memory configuration parameters for model inputs. In some embodiments, the processing device can be a production environment processing device, such as system processing device 260 as described with respect to FIG. 2. Input for the trainable model can include previous memory configuration parameters, randomly generated values, and/or a mix of randomly altered historical values of memory configuration parameters (i.e., quasi-random values of memory configuration parameters). Previous outputs from the trainable model can be used to generate new inputs for the trainable model.

At operation 520, the processing device obtains drive level measurements based on the quasi-random values of the memory configuration parameters to derive model outputs. Drive level measurements can include previous measurements. In some embodiments, initial measurements can be performed by engineers on the memory device to seed the trainable model. In some embodiments, the drive level measurements can be estimated based on memory device characteristics and design requirements.

At operation 530, the processing device determines whether operations 510 and 520 have been repeated N times. Determining the values of memory configuration parameters can be an iterative process. In some embodiments, the processing device can determine how many “N” number of times that operations 510 and 520 are iterated. In some embodiments, operations 510 and 520 can be iterated “N” number of times until the values of the memory configuration parameters satisfy some threshold.

At operation 540, the processing device builds the trainable model using generated trainable inputs and obtained target outputs. Using the generated memory configuration parameter inputs and the measured outputs as targets, the processing device can build a trainable model to predict values of memory configuration parameters based on target outputs (i.e., performance metrics). The processing device can use a supervised training technique such as a linear regression training technique, an SVM regression training technique, a neural network training technique, etc., as described above to build the trainable model.

At operation 550, based on a target output requirement, the processing device determines values of the memory configuration parameters for a memory device. The processing device can implement the trainable model built at operation 540 to predict values of memory configuration parameters. Further details describing using the trainable model can be found above as described in FIG. 3 and FIG. 4. In some embodiments, a new trainable model can be created and trained for each type of memory device (e.g., such as for memory device product families).

At operation 560, the processing device obtains validation results for the memory device based on the determined values of the memory configuration parameters. After predicting values for the memory configuration parameters, the processing device can validate whether the predicted values of the memory configuration parameters will allow the memory device to satisfy various threshold conditions on which performance metrics are based. Predicted values of memory configuration parameters can be valid (i.e., proper) if the values of the memory configuration parameters allow the memory device to satisfy threshold conditions on which one or more performance metric(s) are based. In some embodiments, validation can include repeated testing of the values of the memory configuration parameters to ensure the memory device consistently satisfies the threshold condition(s).

FIG. 6 is a flow diagram of an example method 600 for training a trainable model to predict values of the memory configuration parameters, in accordance with some embodiments of the present disclosure. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 600 is performed by the configuration model 202 via the system processing device 260 of FIG. 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 610, the processing device implementing the method 600 generates training data for training a trainable model to predict values of the memory configuration parameters based on a performance metric for a memory device, wherein the performance metric is based on a memory access operation of the memory device satisfying an expected threshold condition, wherein the values of the memory configuration parameters affect whether the memory access operation satisfies the expected threshold condition. In some embodiments, the processing device can be a production environment processing device, such as system processing device 260 as described with respect to FIG. 2. The trainable model can be a trainable model such as configuration model 202 as described with respect to FIG. 2. The trainable model can be trained by supervision to be a supervised trainable model such as, for example, a linear regression trainable model, a support vector machine (SVM) regression trainable model, or a neural network trainable model. The memory configuration parameters can correspond to and/or include, for example, BER, RBER, a folding threshold, an error trigger rate, a read refresh rate, a QoS threshold condition, a BFEA bin pointer, a deep-check threshold, a read level offset, a RDH window, a temperature compensation value, etc. In some embodiments, operation 610 can include all or part of operations 510 and 520 as described with respect to FIG. 5.

As a part of operation 610, at operation 611, the processing device generates a training input comprising a historical set of values of the memory configuration parameters for a prior memory device fabricated at a production system for manufacturing the memory device. Training input can be represented, for example, as one or more numerical indicators, tables, or memory device metadata. Training input can include quasi-random generated values of memory configuration parameters. In some embodiments, quasi-random generated values of memory configuration parameters are generated from historical values of memory configuration parameters, and/or previous model inputs or outputs. In some embodiments, training input can include memory device manual measurements. In some embodiments, initial measurements can be performed by engineers on the memory device to seed the training input for the trainable model. In some embodiments, training inputs can be estimated based on memory device characteristics and design requirements.

As a part of operation 610, at operation 613, the processing device generates a target output for a first training input, wherein the target output comprises a historical value of the performance metric based on a historical threshold condition of the memory access operation performed by the prior memory device using a second historical set of values of the memory configuration parameters, and an indication of whether the threshold condition is satisfied. Target output can include threshold conditions for memory access operations. Target output can include performance metrics based on satisfying one or more threshold conditions. In some embodiments, target output can reflect specific values of memory configuration parameters associated with a memory access operation. For example, it might be known or discovered by using this trainable model that a memory access operation based on a certain memory configuration parameter value is likely to satisfy the threshold condition for the memory access operation, and so a specific memory configuration parameter value might be targeted (e.g., as a target output of the trainable model). The target output can indicate a relationship between the target output and the first training input.

At operation 620, the processing device provides the training data to the trainable model on (i) a set of training inputs comprising the first training input and (ii) a set of target outputs comprising the target output. The processing device can identify a memory sub-system performance metric based on the performance metric for the memory device. The processing device can store values of memory configuration parameters in, or retrieve historical values of memory configuration parameters from a data structure of the memory sub-system. In some embodiments, operation 620 can include all or part of operation 540 as described with respect to FIG. 5. In some embodiments, the processing device can indicate that the trainable model is ready to be used. In some embodiments, the trainable model can be trained before each use. I.e., before being used to generate predicted values of memory configuration parameters (e.g., such as predicted values of memory configuration parameters 211 as described with respect to FIG. 2), the processing device can retrain the trainable model with the most recently available input data.

In some embodiments, the trainable model can be tested using a corresponding set of features of a generated test set. Once trainable model parameters have been optimized, trainable model testing can be performed to determine whether the trainable model has improved and to determine a current accuracy of the trainable model. In some embodiments, during a trainable model testing, trainable models that do not meet a threshold accuracy can be discarded in favor of trainable models that meet an accuracy threshold.

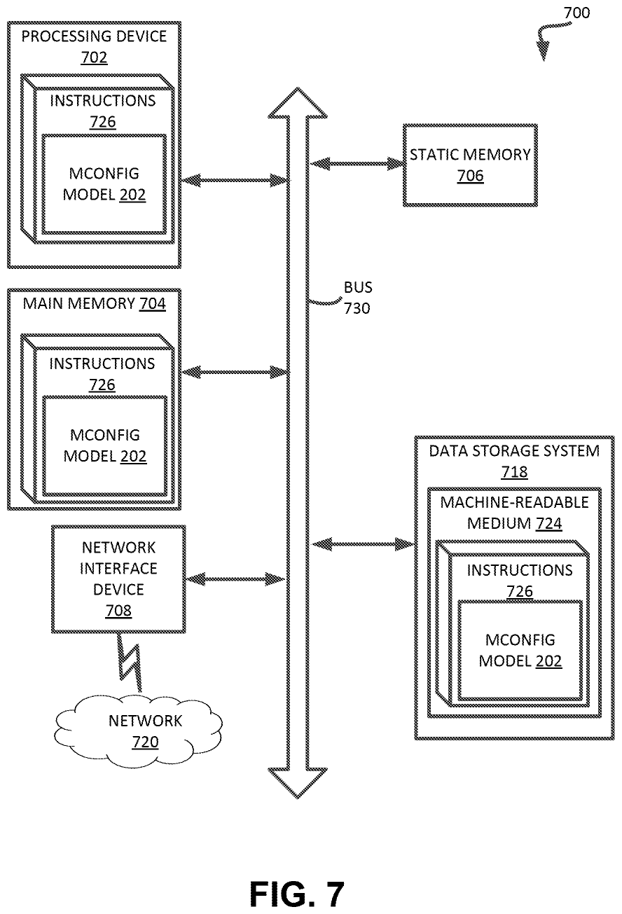

FIG. 7 illustrates an example machine of a computer system 700 within which a set of instructions, for causing the machine to perform any one or more of the methodologies discussed herein, can be executed. In some embodiments, the computer system 700 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the memory configuration parameters component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM) or RDRAM, etc.), a static memory 706 (e.g., flash memory, static random access memory (SRAM), etc.), and a data storage system 718, which communicate with each other via a bus 730.

Processing device 702 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 can also be one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein. The computer system 700 can further include a network interface device 708 to communicate over the network 720.

The data storage system 718 can include a machine-readable storage medium 724 (also known as a computer-readable medium) on which is stored one or more sets of instructions 726 or software embodying any one or more of the methodologies or functions described herein. The instructions 726 can also reside, completely or at least partially, within the main memory 704 and/or within the processing device 702 during execution thereof by the computer system 700, the main memory 704 and the processing device 702 also constituting machine-readable storage media. The machine-readable storage medium 724, data storage system 718, and/or main memory 704 can correspond to the memory sub-system 110 of FIG. 1.

In one embodiment, the instructions 726 include instructions to implement functionality corresponding to a memory configuration parameters component (e.g., the memory configuration parameters component 113 of FIG. 1). While the machine-readable storage medium 724 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory; and
a processing device operatively coupled to the memory, the processing device to perform operations comprising:
providing, as an input to a trainable model, a value of a performance metric based on a threshold condition of a memory access operation performed on a memory device using a set of values of memory configuration parameters;
obtaining as an output from the trainable model, a set of predicted values of the memory configuration parameters; and
responsive to determining that the set of predicted values of the memory configuration parameters satisfies a confidence criterion, updating the memory configuration parameters to reflect the set of predicted values of the memory configuration parameters.

2. The system of claim 1 further comprising:
updating a value of a confidence indicator, wherein the value of the confidence indicator reflects whether the confidence criterion was satisfied.

3. The system of claim 2 further comprising:
providing, to a user interface device, the output from the trainable model as one or more numerical indicators; and
providing, to the user interface device, the value of the confidence indicator.

4. The system of claim 1, wherein the trainable model is a regression model, wherein the regression model determines a line that matches a set of datapoints plotted along a first dimension with respect to a second dimension, wherein the first dimension is the input to the trainable model, wherein the second dimension is the output from the trainable model.

5. The system of claim 1, wherein the trainable model is a neural network, wherein the output from the trainable model is generated by passing the input to the trainable model through one or more nodes of one or more layers, wherein a multivariate function represents a transformation caused by the one or more nodes of the one or more layers between the input to the trainable model and the output from the trainable model.

6. The system of claim 1, wherein the trainable model is a decision tree model comprising a set of branches, wherein a first branch set of branches comprises the threshold condition, wherein a second branch of the set of branches comprises the confidence criterion, wherein a first leaf of the decision tree model comprises the output from the trainable model and a branch path, the branch path indicating a series of branches of the set of branches between the input to the trainable model and the output from the trainable model.

7. The system of claim 1, wherein the trainable model is a rule engine evaluating a set of rules, wherein a first rule of the set of rules comprises the threshold condition, wherein a second rule of the set of rules comprises the confidence criterion, wherein a first action of a set of actions comprises determining the value of the performance metric.

8. The system of claim 1, wherein updating the memory configuration parameters comprises:
updating one or more entries of a data structure accessible to a memory sub-system comprising the memory device, wherein each entry of the one or more entries of the data structure comprises one or more values of the set of values of the memory configuration parameters.

9. The system of claim 1, wherein the memory configuration parameters comprise at least one of: a folding threshold, a forgiveness threshold, a bit error rate (BER), a residual bit error rate (RBER), an error trigger rate, a read refresh rate, a quality of service (QOS) threshold, a block family error avoidance (BFEA) bin pointer, a deep-check threshold, a read level offset threshold, a read disturb handling (RDH) threshold, or a temperature compensation value.

10. A method comprising:
generating, by a processing device, training data for training a trainable model to predict a predicted set of values of memory configuration parameters based on a value of a performance metric, wherein the value of the performance metric is based on a threshold condition of a memory access operation performed by a memory device using a set of values of the memory configuration parameters, wherein to generate the training data, the processing device to perform operations further comprising:
generating a training input comprising a historical set of values of the memory configuration parameters for a prior memory device fabricated at a production system for manufacturing the memory device;
generating a target output for a first training input, wherein the target output comprises a historical value of the performance metric based on a historical threshold condition of the memory access operation performed by the prior memory device using a second historical set of values of the memory configuration parameters, and an indication of whether the threshold condition is satisfied; and
providing the training data to the trainable model on (i) a set of training inputs comprising the first training input and (ii) a set of target outputs comprising the target output.

11. The method of claim 10 further comprising:
identifying a value of a sub-system performance metric for a memory sub-system, wherein the memory sub-system comprises the memory device, and wherein the sub-system performance metric comprises the performance metric for the memory device.

12. The method of claim 11 further comprising:
programming the historical set of values of the memory configuration parameters to a data structure comprised by the memory sub-system.

13. The method of claim 10, wherein each training input of the set of training inputs maps to a corresponding target output of the set of target outputs.

14. The method of claim 10, wherein the trainable model comprises at least one of a regression model, a neural network, a decision tree model, or a rule engine.

15. The method of claim 10, wherein the memory configuration parameters comprise at least one of: a folding threshold, a forgiveness threshold, a bit error rate (BER), a residual bit error rate (RBER), an error trigger rate, a read refresh rate, a quality of service (QOS) threshold, a block family error avoidance (BFEA) bin pointer, a deep-check threshold, a read level offset threshold, a read disturb handling (RDH) threshold or a temperature compensation value.

16. A non-transitory computer-readable storage medium comprising instructions that, when executed by a processing device, cause the processing device to perform operations comprising:
providing, as an input to a trainable model, a value of a performance metric based on a threshold condition of a memory access operation performed on a memory device using a set of values of memory configuration parameters;
obtaining as an output from the trainable model, a set of predicted values of the memory configuration parameters; and
responsive to determining that the set of predicted values of the memory configuration parameters satisfies a confidence criterion, updating the memory configuration parameters to reflect the set of predicted values of the memory configuration parameters.

17. The non-transitory computer-readable storage medium of claim 16, the operations further comprising:
updating a value of a confidence indicator, wherein the value of the confidence indicator reflects whether the confidence criterion was satisfied;
providing, to a user interface device, the output from the trainable model as one or more numerical indicators; and
providing, to the user interface device, the value of the confidence indicator.

18. The non-transitory computer-readable storage medium of claim 16, the operations further comprising:
transmitting, to a processing device, an instruction to initiate a validation check on the memory device, wherein the validation check determines whether the memory access operation performed on the memory device using the set of predicted values of the memory configuration parameters satisfies the threshold condition.

19. The non-transitory computer-readable storage medium of claim 16, wherein the trainable model comprises at least one of a regression model, a neural network, a decision tree model, or a rule engine.

20. The non-transitory computer-readable storage medium of claim 16, wherein the memory configuration parameters comprise at least one of: a folding threshold, a forgiveness threshold, a bit error rate (BER), a residual bit error rate (RBER), an error trigger rate, a read refresh rate, a quality of service (QOS) threshold, a block family error avoidance (BFEA) bin pointer, a deep-check threshold, a read level offset threshold, a read disturb handling (RDH) threshold or a temperature compensation value.
